(19) United States
(12) Patent Application Publication
(10) Pub. No.: US 2005/0029330 A1
(43) Pub. Date: Feb. 10, 2005

(54) Process and apparatus for friction stir welding

(76) Inventor: Gabriel Kohn, Lehavim (IL)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/472,026

(22) PCT Filed: Mar. 14, 2002
(86) PCT No.: PCT/IL02/00207

(30) Foreign Application Priority Data
Mar. 19, 2001 (IL) 142101

(51) Int. Cl. B23K 20/12

(52) U.S. Cl. 228/112.1

(57) ABSTRACT

The invention provides a method for a friction stir welding process, which comprises the steps of conventional stir welding—including applying friction to the areas of the workpiece to be welded by means of a rotating tool (20) that has a large shoulder that is pressed downwards on the workpiece and has a probe inserted into the material to be welded. The tool being advanced along the weld line. The method additionally comprises generating a laser beam (28) and collimating and focusing said beam on the workpiece in the weld region (29) ahead of the rotating tool. The invention also provides an apparatus for friction stir welding, which comprises the elements of conventional stir welding apparatus—including a rotating tool (20) that has a large shoulder and has a probe for insertion into the material to be welded, a mechanism for holding the tool and rotating and advancing it, a mechanism for pressing the tool shoulder downwards on the workpiece, and a mechanism for clamping the workpieces. The apparatus further comprises a laser beam generator (25), a laser beam conduit (26), preferably consisting of optical fibers, and collimator (28) and focusing optics for focusing the laser beam on the desired area of the workpiece.

### FIELD OF THE INVENTION

This invention relates to an improvement of the welding process known as friction stir welding

### BACKGROUND OF THE INVENTION

Friction stir welding is a welding process in which the parts to be joined are plasticized at and in the vicinity of their contact surfaces by heat generated by friction. Said parts to be joined will be called hereinafter, together, “the workpiece”. In the typical form of this process (see “Friction Stir—Where We Are and Where We are Going” by Wayne Thomas et al., TWI Bulletin, Vol. 39, May/June 1998), friction is generated between the workpiece and a rotating tool (of harder material than the workpiece), to plasticize the abutting weld region. Commonly, the tool is shaped with a large diameter shoulder and a specially profiled tool of small diameter (called hereinafter “the probe”) which is plunged into the joint region and is rotated while pressure is exerted on the said shoulder to force it downwards onto the workpiece. The friction stir welding process is disclosed in WO 93/10935.

A modification of the process is described in WO 99/39861, and consists in applying a moving induction coil as a heat source in front of the rotating tool, to provide controlled heating of a limited volume of the weld material beneath the tool shoulder and plasticize it. In this way, it is said that the main function of the rotating probe is to control the flow pattern of the preheated material and to break up outside skin introduced from the welded members.

The said modification of the friction stir welding process, however, is not fully satisfactory. All conductive materials, that are affected by the current passing through the induction coil, are heated, including clamping devices and even the tool probe, which is highly undesirable. Induced currents may flow across the path of the weld and cause spark formation. The heating by means of induction coil, of course, applies to conducting materials only and not, for example, to plastics or ceramics. Actually, the present technology of friction stir welding, in all its forms, is presently mainly applied to aluminum and aluminum alloys although it is suitable to other metals and also to non-metallic materials such as plastics and medium and low melting point ceramics.

It is therefore a purpose of this invention to provide a friction stir welding process and apparatus that are free of the drawbacks of the known stir welding processes and apparatus.

It is another purpose to provide a friction stir welding process and apparatus in which the parts to be joined are heated by means that are applicable to all materials.

It is a further purpose to provide a friction stir welding apparatus and method in which heat is applied to the workpiece in a precise and localized manner such that both the location of heating and amount of power reaching the workpiece are known and predetermined.

It is a still further purpose to provide a friction stir welding apparatus and method that permits successfully to weld high-melting temperature materials.

Other purposes and advantages of the invention will appear as the description proceeds.

### SUMMARY OF THE INVENTION

The process of the invention comprises the steps of conventional stir welding—including applying friction to the areas of the workpiece to be welded by means of a rotating tool that has a large shoulder that is pressed downwards on the workpiece and has a probe inserted into the material to be welded, said tool being advanced along the weld line—and additionally comprises generating a laser beam and collimating and focusing said beam on the workpiece in the weld region ahead of the rotating tool.

The power applied by the laser beam depends on the nature of the material being welded, the dimensions of the workpiece, the characteristics of the rotating tool, and the heat dispersion from the workpiece, and therefore cannot be generally specified. However, the values of power that are required from the laser can be easily determined in each individual instance, since it must be such that it can raise the temperaure of the workpiece to a temperature that is comprised between 0.4Tₘ and Tₘ where Tₘ, is the melting temperature of the workpiece, in degrees Kelvin, before the tool begins to rotate. Typical starting temperatures for different materials are:
Mg≅300° C.
Al≅300°-350° C.
Cu≅600° C.
Steel≅700° C.
Ceramics≅2000° C.

The laser beam may be generated by any laser system capable of producing enough power to achieve the desired temperature of the workpiece. The laser beam is led to the collimating and focusing elements by an optical fiber cable or by other optical means.

The temperature of the workpiece that is heated by the laser beam is monitored on-line by any conventional temperature measuring device, for example a thermocouple or infrared temperature measuring camera. Preliminary calibration of the temperature of the workpiece as a function of laser energy and time of heating may alternatively be employed to infer its temperature.

The invention also includes an apparatus for friction stir welding, which comprises the elements of conventional stir welding apparatus—including a rotating tool that has a large shoulder and has a probe for insertion into the material to be welded, a mechanism for rotating and advancing it and a mechanism for pressing the tool shoulder downwards on the workpiece. In the preferred embodiment of the invention, the mechanisms for holding, rotating and pressing the tool sholder down onto the workpiece as well as the mechanisms for clamping the workpieces and advancing them relative to the tool are all contained in a single machine.

The invention further comprises a laser beam generator, a laser beam conduit, preferably consisting of optical fibers, and a collimator and focusing optics for focusing the laser beam on the desired area of the workpiece. It is also possible to use the optical fibre cable without any focusing optics to heat the workpiece. In other embodiments of the invention, conventional laser beam steering optics, well known to persons skilled in the art, are employed instead of the fibre optic cable to lead the beam to the desired area on the workpiece.

The laser beam generator is chosen from among comercially available solid state, liquid, or gaseous lasers. The optical components preferably comprise a single element collimating lens and a single element focusing lens, but can be any type of collimating and focusing systems based on reflective, diffracting, or refractive optics. Further, the apparatus comprises a mechanism for rotating and/or displacing the collimator and focusing optics and/or the optical fiber conduit and/or the laser generator, to keep the laser beam focused on the desired areas of the workpiece as the rotating tool progresses along the weld path. While such mechanism can be manually actuated by an operator, it can be actuated by a controller as a function of the displacements of the rotating tool, and in this case the controller is a part of the apparatus of the invention.

### BRIEF DESCRIPTION OF THE DRAWINGS

In the drawings:

FIG. 1 is a schematic representation of a conventional friction stir welding apparatus, according to the prior art;

FIG. 2A is a schematic illustration of a probe used in the present invention;

FIGS. 2B and 2C are schematic illustrations of probes used in tools of prior art friction stir welding apparatus;

FIG. 3 is a schematic representation of an embodiment of apparatus according to the invention;

FIG. 4 is a schematic representation of an embodiment of the laser and optical system according to the invention;

FIG. 5 is a reproduction of a photograph showing two Mg AZ91 plates joined by LAFSW;

FIG. 6 is a reproduction of a photograph showing a cross-section of the plates of FIG. 5; and

FIG. 7 is a reproduction of a photograph showing the microstructure of the weld of FIG. 6.

### DETAILED DESCRIPTION OF PREFERRED EMBODIMENTS

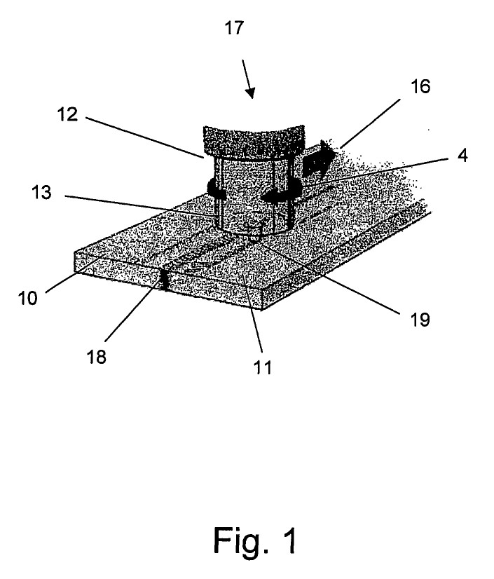

FIG. 1 (the content of which is taken from a catalog describing the ESAB SuperStir—Friction Stir Welding System, Esab Welding Equipment AB, Laxa, Sweden) schematically illustrates a conventional, prior art apparatus for friction stir welding. Numerals 10 and 11 indicate two parts of the workpiece that are to be joined by welding. Numeral 12 indicates the upper part of the rotating tool, which has a wide shoulder 13 that is compressed down on the workpiece by means not shown. Arrow 14 indicates the rotation of the tool. Arrow 16 indicates the direction of the linear motion of the tools along the weld line, and arrow 17 the force that presses the tool down on the workpiece. The area 18 is the weld area.

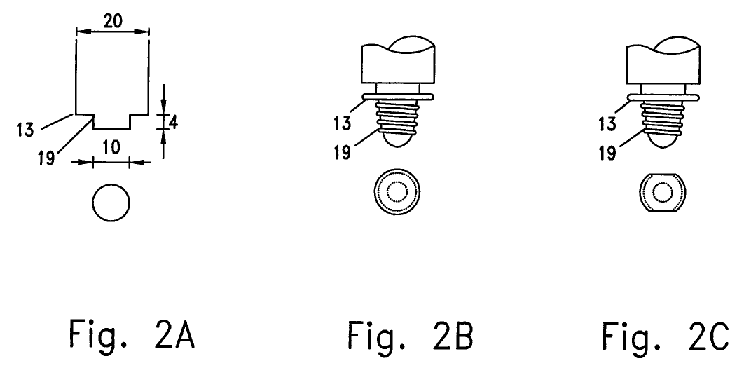

Since the probe 19 that constitutes the lowermost portion of the rotating tool and that is inserted into the material that is being welded is not visible, it is only symbolically indicated in FIG. 1. FIGS. 2A and 2B illustrate two number of such probes. FIG. 2B and 2C comprise in their upper part a schematic side view of the tool, wherein the shoulder is designated by numeral 13 and the probe by 19. The lower part of each figure is a schematic section of the probe showing its shape. The content of FIGS. 2B and 2C is taken from the cited article of Wayne Thomas et al. These are only two of several specialized, complex, and relatively expensive probes that exist in the prior art. In contrast, FIG. 2A schematically shows the tool employed to carry out the welding described in the example below. This probe is simply a cylinderical pin of diameter approximately 10-15 mm and length suitable to the thickness of the material to be welded. Typical, non-limitative, dimensions are shown in the figure.

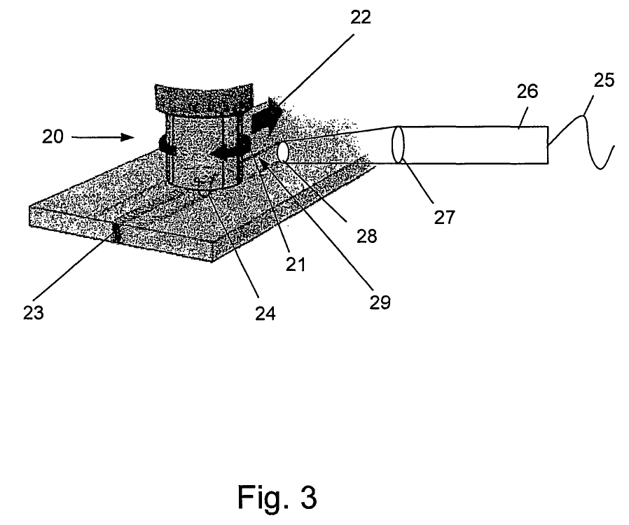

FIG. 3 schematically illustrates an embodiment of the invention. The tool, generally indicated at 20, can be conventional and such as is known and illustrated in the prior art. 21 indicates its rotation and arrow 22 the direction of its displacement along the weld line. 23 is the upper surface of the weld. 24 symbolically indicates the probe that constitutes the lowermost portion of the tool. Typical probes according to the present invention, or such as are known and illustrated in the prior art, are illustrated in FIGS. 2A to 2C.

Numeral 25 is an optical fiber cable which is connected to the laser beam generator. This latter is not illustrated since it can be conventional. Numeral 26 schematically indicates the collimator and numeral 27 schematically indicates the focusing optics. Numeral 28 schematically indicates the beam that is being focused on an area 29 in front of the rotating tool. Typically the laser beam impinges on the work surface approximately 5 mm in front of the probe and is adjusted to be slightly out of focus to prevent localized melting of the workpiece and to cause relatively uniform preheating of the entire weld zone. By shifting the spot, differential heating is applied to the two pieces in cases wherein the workpieces to be welded have a relatively large difference in melting temperature. In some cases, the focusing optics is so configured such as to use the laser beam to heat the workpieces from the bottom while the tool works from the top side. Additionally, absorptive coatings are sometimes applied to the area of the weld in order to increase the absorption of laser energy.

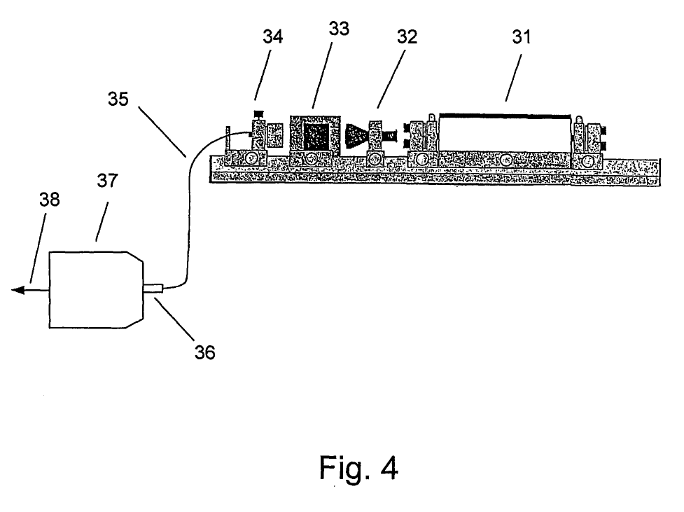

FIG. 4 schematically represents the laser and optical system according to the invention. All of the elements shown in the figure are comercially available from many sources. The elements used to carry out the example described below were supplied by U.S. Laser Corporation, Wyckoff, N.J., U.S.A. Numeral 31 is the laser resonator. This is a water cooled Nd:YAG laser that requires a maximum input power of 20 kW and supplies up to 700 watts of continuous output power at a wavelength of 1064 nm.

Numeral 32 is an upcollimator necessary to limit divergence of the laser beam and to match it to the fiber optic input coupler. Numeral 33 is a beam dump power meter and numeral 34 a fiber optic input coupler. The input coupler comprises a 37.5 mm multi-element coupling lens as well as support and adjustment elements for the lens and cable. Numeral 35 is a conventional 800 micron core step index optical fiber five meters long (the cable can of course be of a different length depending on the distance from the laser to the welding probe). Numeral 36 represents the coupling of the fiber optic cable to the output coupler 37. The output coupler contains two 30 mm diameter single element lenses. The first lens is a 60 mm focal length collimating lens and the second a 75 mm focal length objective lens. Numeral 38 represents the focused beam that is directed to the work surface.

In operation, the laser assembly is mounted on a table near the work surface. A tool of the type shown in FIG. 2A, for example, is mounted in the tool holder of a conventional milling machine and the pieces to be joined (for example, two plates of Mg metal to be butt welded) are clamped side-by-side on the table of the milling machine such that the tool will stay positioned above the seam to be welded as the moving table carries the work relative to the rotating tool and the friction stir welding is carried out.

In the method of the invention, the output coupler of the laser is attached to the tool holder housing of the milling machine and aligned such that a slightly out-of-focus spot of laser energy falls on the seam between the two pieces to be welded. The spot is adjusted such that it has a diameter approximately equal to that of the probe on the tool (10-15 mm) and falls about 5 mm in front of the probe.

In the process of the invention, the seam is first preheated by the laser. When the metal is heated to the proper temperature, the tool is started spinning and plunged into the seam. At the same time the table of the milling machine starts to move and the heat of friction adds to the heat supplied by the laser to provide the conditions necessary to carry out the friction stir weld.

In one trial, the laser was used to preheat the seam bewtween two Mg plates to 300-320° C. After the tool started to turn and was plunged into the seam, the temperature rose to 400-420° C., at which temperature the welding was carried out. This example demonstrates one of the major advantages of the invention over the prior art. In the method of the invention only about 35% of the heat energy needed to achieve the temperature necessary for welding is supplied by the rotating tool. One of the consequences of this is that the forces needed to secure the work pieces are much smaller, simplifying the clamping requirements.

The following example illustrates the invention without limiting it in any way:

Two 4 mm thick Mg AZ91 alloy plates were clamped to the table of a conventional 3HP Pinnacle Turret Vertical Milling Machine. The pieces were clamped to the table, using conventional clamping jigs, with four 23-mm bolts. A straight 20 mm diameter high-speed steel cylinderical probe with a 9 mm diameter, 4 mm long pin (of the type schematically shown in FIG. 2A) was inserted into the toolholder on the spindle of the milling machine. The spindle rotation speed was about 1700 rpm.

The laser and optical system used was that described above and schematically illustrated in FIG. 4. The laser beam was transmitted to the welding table with a 800μ core step index fiber optic cable 5 m long. The beam was defocused to form a 10 mm spot ahead of the rotating probe. Laser power was set to about 200 W. When the sample temperature reached about 320° C., the rotating probe was plunged into the seam between the two plates and the table of the milling machine was advanced at the rate of about 50 mm/min. Due to the laser heating effect, the resistance both to the penetration of the probe into the material and to the motion of the spindle relative to the table was negligible.

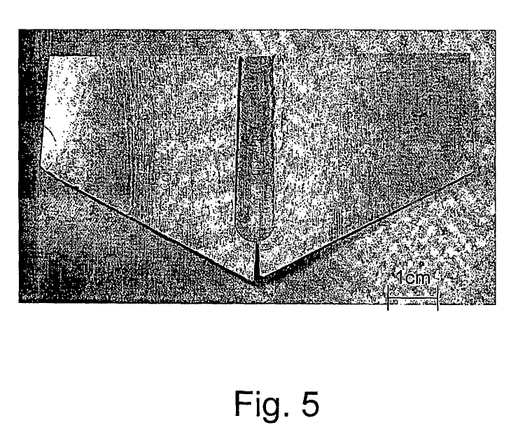

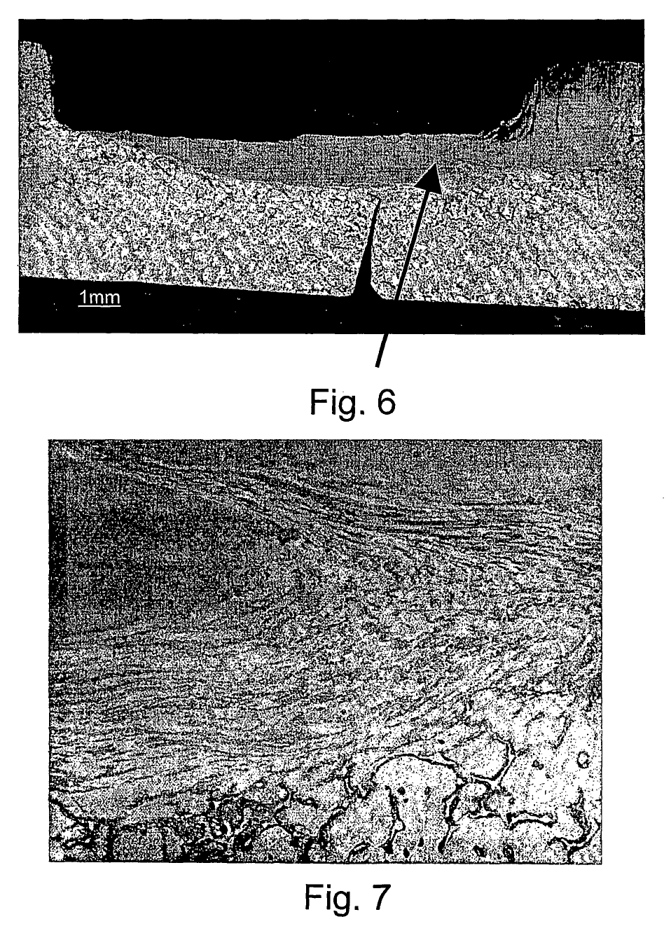

FIGS. 5-7 are reproductions of photographs. FIG. 5 is a general view of two Mg. AZ91 plates joined by the laser assisted friction stir welding (LAFSW). In the example, a partial penetration weld was obtained. FIG. 6 is a cross-section showing the weld of FIG. 5. FIG. 7 shows the microstructure of the weld in the area indicated by the arrow in FIG. 6. The plates were welded with no visible distortion and no defects were detected in the microstructure of the weld.

While examples of the invention have been given by way of illustration, it will be understood that the invention may be carried out with many modifications, variations and adaptations without departing from its spirit or exceeding the scope of the claims.

1. Friction stir welding process, which comprises the elements of conventional stir welding and additionally comprises generating a laser beam, leading, collimating and focusing said laser beam on the desired area of the workpiece.

2. Friction stir welding process according to claim 1, wherein the power applied by the laser beam is such as to bring the workpiece to a temperature that is comprised between 0.4Tₘ and Tₘ, where Tₘ is the melting temperature, in degrees Kelvin, of said workpiece.

3. Apparatus for friction stir welding, which comprises the elements of conventional stir welding apparatus—including a rotating tool that has a large shoulder and has a probe for insertion into the material to be welded, a mechanism for holding the tool and rotating and advancing it, a mechanism for pressing the tool shoulder downwards on the workpiece, and a mechanism for clamping the workpieces—and further comprises a laser beam generator, a laser beam conduit, preferably consisting of optical fibers, and collimator and focusing optics for focusing the laser beam on the desired area of the workpiece.

4. Apparatus for friction stir welding according to claim 3, wherein the power of the laser beam is such as to bring the workpiece to a temperature from 0.4Tm to Tm, where Tm is the melting temperature, in degrees Kelvin, of the workpiece.

5. Apparatus for friction stir welding according to claim 4, wherein the laser beam generator is a water cooled Nd:YAG laser.

6. Apparatus for friction stir welding according to claim 3, wherein a simple, relatively inexpensive machine comprises the mechanism for clamping the workpieces, the mechanism for holding the tool and rotating and advancing it, and the mechanism for pressing the tool shoulder downwards on the workpiece.

7. Apparatus for friction stir welding according to claim 6, wherein the simple, relatively inexpensive machine is a conventional milling machine.

8. Apparatus for friction stir welding according to claim 3, wherein the laser beam conduit consists of conventional laser beam steering optics.

9. Apparatus for friction stir welding according to claim 3, wherein the laser beam conduit consists of optical fibers.

10. Apparatus for friction stir welding according to claim 3, wherein the collimator comprises any type of collimating system based on reflective, diffracting, or refractive optics, preferably a single element collimating lens.

11. Apparatus for friction stir welding according to claim 3, wherein the focusing optics comprises any type of focusing system based on reflective, diffracting, or refractive optics, preferably a single element focusing lens.

12. Apparatus for friction stir welding according to claim 9, wherein no focusing means are employed for focusing the laser beam that exits from the optical fibers onto the desired area of the workpiece.

13. Apparatus for friction stir welding according to claim 3, wherein absorptive coatings are applied to the area of the weld in order to increase the absorption of laser energy.

14. Apparatus for friction stir welding according to claim 3, further comprising a mechanism for rotating and/or displacing the collimator and focusing optics and/or the optical fiber conduit and/or the laser generator, to keep the laser beam focused on the desired areas of the workpiece as the rotating tool progresses along the weld path.
